(19) United States
(12) Patent Application Publication
(10) Pub. No.: US 2003/0046687 A1
(43) Pub. Date: Mar. 6, 2003

(54) Techniques for manipulating programming breaks in streaming content

(75) Inventors: Richard Hodges, Oakland, CA (US); Keith McMillen, Berkeley, CA (US)

Correspondence Address: BEYER WEAVER & THOMAS LLP, P.O. BOX 778, BERKELEY, CA, 94704-0778, US

(73) Assignee: Octiv, Inc., Berkeley, CA (US)

(21) Appl. No.: 10/100,258

(22) Filed: Mar. 14, 2002

Related U.S. Application Data
(60) Provisional application No. 60/317,869, filed on Sep. 6, 2001.

(51) Int. Cl. H04N 7/025; H04N 7/10

(52) U.S. Cl. 725/32; 725/36

(57) ABSTRACT

Methods and apparatus are described for enabling a computer to manipulate programming breaks in an original digital content stream. One of a plurality of substitute durations is selected with reference to a first duration of a first programming break. The selected substitute duration is substituted for the first duration, thereby generating a modified digital content stream having a modified programming break.

### RELATED APPLICATION DATA

The present application claims priority from U.S. Provisional Patent Application No. 60/317,869 for METHOD FOR TIME ADJUSTMENT FOR SUBSTITUTE COMMERCIAL BREAKS IN BROADCAST PROGRAMS, filed on Sep. 6, 2001, the entire disclosure of which is incorporated herein by reference for all purposes.

### BACKGROUND OF THE INVENTION

The present invention relates to systems which transmit streaming digital content. More specifically, the present invention provides techniques for manipulating the duration of programming breaks in digital content streams to facilitate insertion of substitute content into the programming breaks.

The evolution of channels for delivering content has resulted in the potential for delivering content generated specifically for one geographic region to individuals in other regions for whom the content has little relevance. For example, many traditional broadcast radio stations are now also providing streaming digital versions of their broadcasts over the Internet which are accessible anywhere in the world. Obviously, commercial spots for businesses located in the geographic region in which the broadcast station is physically located will have little meaning and be of virtually no use to listeners in other parts of the country or the world. In addition, the content associated with such commercial spots may have associated royalty obligations which accrue to undesirable levels due to the much more widespread distribution of the spots than originally intended.

To deal with this issue, Internet radio stations have taken up the practice of substituting content in such programming breaks. The substituted content may take the form of geographically relevant commercial spots for the region to which a particular stream is directed, or an innocuous instrumental interlude. One of the problems with this approach is the fact that the duration of the substituted content is often not the same as the duration of the programming break into which it is inserted.

If the duration of the substituted content is shorter than the programming break, the remaining time must be filled with, for example, instrumental music, to avoid dead air. On the other hand, if the duration of the substituted content is longer than the programming break, the content is often unceremoniously cut off. In either case, listeners experience a significantly lower production quality than that to which they are accustomed from traditional broadcast radio.

In view of the foregoing, it is desirable to provide techniques by which content may be substituted in programming breaks in digital content streams without unduly detracting from the production quality of the listener's experience.

### SUMMARY OF THE INVENTION

According to the present invention, techniques are provided by which content may be accurately and efficiently substituted into programming breaks in a digital content stream. According to various embodiments, the present invention enables manipulation of the durations of such programming breaks to correspond to the durations of content to be inserted into the programming breaks. According to a specific embodiment, the duration of a programming break is set to one of a finite set of predetermined durations with reference to the original duration of the programming break.

Thus, the present invention provides methods and apparatus for enabling a computer to manipulate programming breaks in an original digital content stream. One of a plurality of substitute durations is selected with reference to a first duration of a first programming break. The selected substitute duration is substituted for the first duration, thereby generating a modified digital content stream having a modified programming break.

A further understanding of the nature and advantages of the present invention may be realized by reference to the remaining portions of the specification and the drawings.

### BRIEF DESCRIPTION OF THE DRAWINGS

FIG. 1 is a simplified block diagram of an exemplary system in which a specific embodiment of the present invention may be practiced.

FIG. 2 is a simplified representation of a particular aspect of a specific embodiment of the invention.

FIG. 3 is an exemplary representation of two digital content streams according to a specific embodiment of the invention.

FIG. 4 is a flowchart illustrating a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order not to unnecessarily obscure the present invention.

The techniques of the present invention may be implemented in a variety of ways. For example, various embodiments of the invention are implemented entirely in software which may be executed on one or more of any of a wide variety of computer platforms, e.g., personal computers, workstations, servers, embedded digital signal processors, handheld or portable devices, etc., in any of a wide variety of network topologies. However, it will be understood that the basic signal processing blocks of such embodiments may be implemented in other ways and remain within the scope of the invention. For example, these processing blocks may be implemented in application specific integrated circuits (ASICs) or programmable logic devices (PLDs). Hardware implementations of the processing blocks of the present invention are also contemplated.

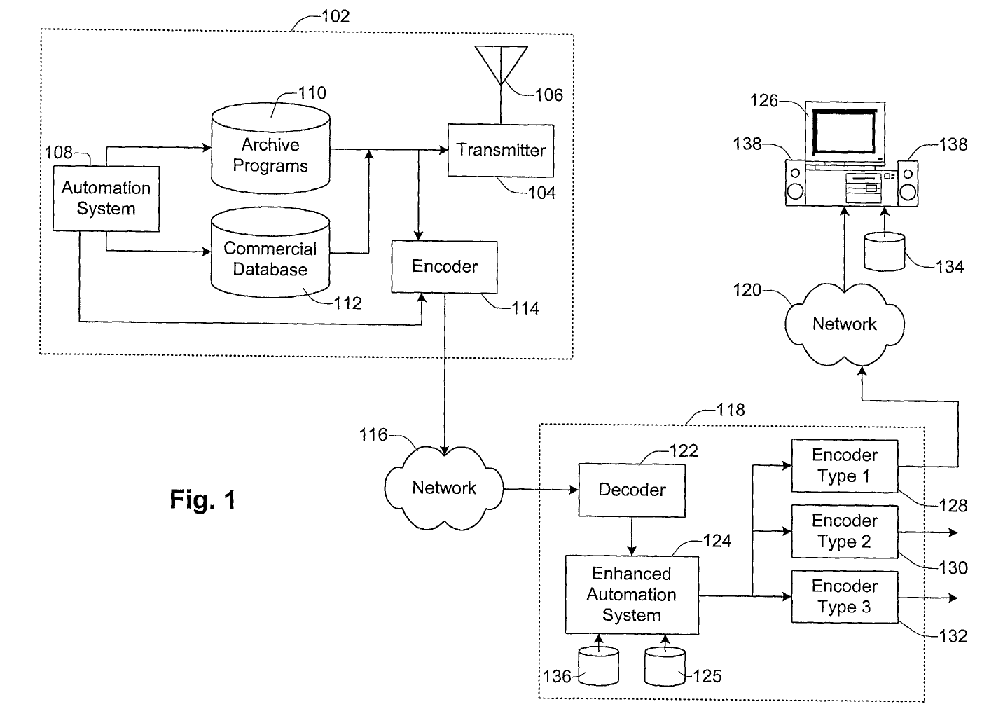

FIG. 1 is a simplified block diagram of an exemplary system in which a specific embodiment of the present invention may be practiced. The system shown is a so-called Internet radio station. However, it will be understood that the use of such a system is merely for the purpose of describing a specific implementation and that the invention is not limited to such systems. Rather, the invention may be employed to manipulate the duration of specific segments, e.g., programming breaks, in any system delivering streaming digital content.

Referring now to FIG. 1, a traditional broadcast radio station 102 employs a transmitter 104 and an antenna 106 to broadcast an AM, FM, or digitally encoded radio program through the atmosphere to tuned receivers in the surrounding geographic region. The radio program is generated by an automation system 108 using content in a program archive 110 and a commercial database 112. That is, the automation system operates according to a set of rules to combine content from archive 110 and database 112 into a single program. The details by which this is accomplished are well known and not particularly relevant to the present invention.

Many broadcast radio stations also have a presence on the Internet or World Wide Web. That is, a version of the radio program being broadcast over the air waves is also provided as streaming digital audio over the Internet. This may be accomplished as shown in FIG. 1 by digitally encoding the radio program (e.g., using encoder 114) and transmitting the digital audio stream over a network 116 to a streaming host 118 which then provides the digital audio stream over a wide area network 120, e.g., the Internet.

It will be understood that the network details shown in FIG. 1 may be varied considerably without departing from the invention. For example, streaming host 118 may be server located in the same physical facility as radio station 102 or at some remote location. In the former case, network 116 might be a local area network (LAN), while in the latter, networks 116 and 120 might be portions of a wide area network such as, for example, the Internet. In addition, the encoding and decoding performed by encoder 114 and decoder 122 may be done according to any of a variety of digital codecs, e.g., Windows Media, Real Audio, MP3, Quicktime, etc.

In addition, and for purposes of this discussion, a digital content stream is received by enhanced automation system 124 in streaming host 118 which manipulates the duration of programming breaks in the digital stream according to the invention. However, this function need not be performed by streaming host 118. Rather, additional network devices between host 118 and end users (e.g., client 126) may perform this function without departing from the scope of the invention. According to other contemplated embodiments, all or some portion of this function may even be performed by client 126.

The encoded digital stream received by host 118 and decoder 122 also includes information provided to encoder 114 by automation system 108 regarding the segments in the radio program. That is, this information identifies the nature of each segment (e.g., song, commentary, station identification break, or commercial spot) and its duration. As will be discussed, this information is employed by enhanced automation system 124 according to the present invention to identify programming breaks and to manipulate their durations. According to a specific embodiment, enhanced automation system 124 also replaces the original content in the programming breaks with filler content which may be, for example, instrumental music.

Once enhanced automation system 124 manipulates the durations of the programming breaks in the digital content stream and introduces the filler content (e.g., from archive 125), host 118 may encode the digital content stream according to any of a wide variety of codecs with different bit rates (encoders 128-132) for transmission to end users (e.g., client 126). Such codecs may include, for example, Real Media, Windows Media, mp3, etc.

In the described embodiment, client 126 has a locally stored archive 134 of content, e.g., commercial spots, which is downloaded from local archive 136 to client 126 as information embedded in transmissions between host 118 and client 126. This content is then inserted into the modified programming breaks for playing over speakers 138. Such an approach is used, for example, in digital audio streaming software and services available from Hiwire, Inc., of Los Angeles, Calif.

According to various specific embodiment and as will be discussed below, the duration of each the programming breaks is modified such that it corresponds to one of a plurality of substitute durations. According to one such embodiment, the substitute durations correspond to the durations of the available content in archive 134. In this way, the transitions between program segments can be made much more smoothly and efficiently, i.e., without cutting off the inserted content or leaving excess time after it ends. It will be understood, of course, that the insertion of the alternate content into the modified programming breaks may occur in host 118 or some other intermediate point rather than client 126 without departing from the invention.

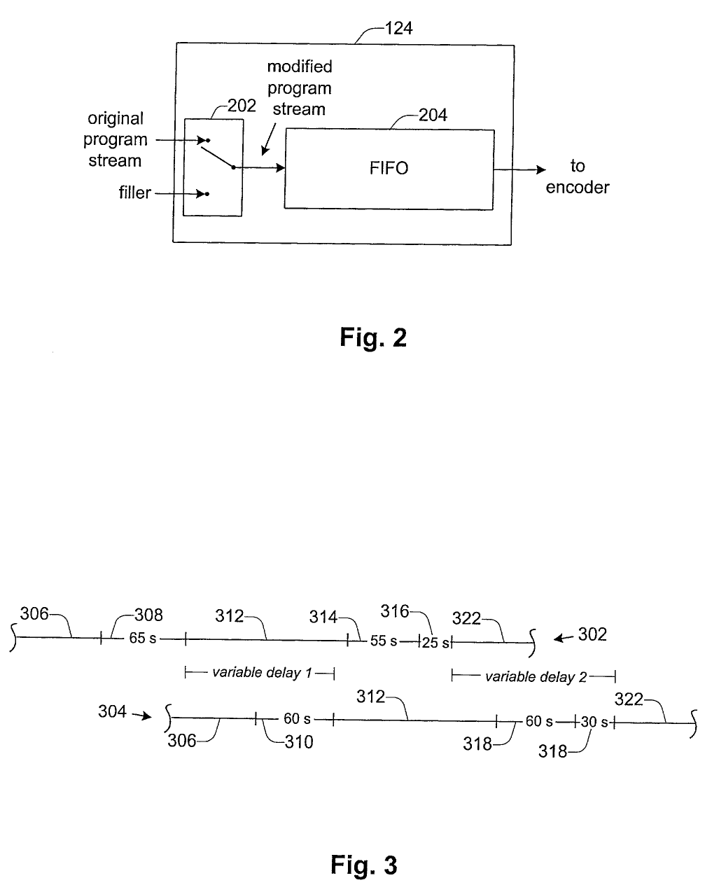

FIG. 2 is a simplified diagram conceptually illustrating operation of a portion of enhanced automation system 124 according to a specific embodiment of the invention. FIG. 3 is an exemplary representation of two digital content streams, the first being the original program stream 302 received by enhanced automation system 124, and the second being a modified program stream 304 after programming break durations have been manipulated and filler content inserted.

The process by which the modified stream is generated from the original stream is represented by a “switch” block 202 which alternately and intelligently provides a first-in-first-out (FIFO) buffer 204 with data from the original program stream and a filler content archive. As discussed above, the function(s) described with reference to block 202 may be implemented using any of a wide variety of software and/or hardware techniques. Each time a programming break is encountered in the original program stream, the data entering the FIFO come from the filler archive. The duration of the filler segment is determined with reference to the duration of the programming break in the original stream. According to a specific embodiment, the duration of the filler segment is selected from a plurality of substitute durations, the selected substitute duration being closest in duration to the duration of the programming break.

Thus, for example, in FIG. 3, a music segment 306 is followed by a programming break 308 of 65 seconds. Assuming the available substitute durations are 15, 30, 45, and 60 seconds, respectively, block 202 selects 60 seconds and substitutes 60 seconds of filler data (i.e., segment 310) for the programming break content, followed immediately by the data from the next music segment 312. This process is then repeated for subsequent programming breaks 314 and 316 resulting in modified breaks 318 and 320. Appropriate local content may then be inserted into the modified programming breaks as described above.

Because the duration of the music segments remains unaltered, the delay experienced by each successive music segment is variable in accordance with the extent to which the intervening programming breaks have been altered. Thus, if the delay between the two versions of segment 312 (variable delay 1) is one minute, the delay between the two versions of segment 322 (variable delay 2) would be 1 minute and 10 seconds given that the intervening programming breaks (314 and 316) were altered by a combined increment of 10 seconds.

It should be noted that the FIFO 204 will have some maximum amount of data it can hold at any particular time, e.g., 3 minutes of audio data samples. According to a specific embodiment in which data are removed from FIFO 204 and transmitted to subsequent encoders at a constant rate, it is important that the variable delay introduced by the manipulation of programming breaks not result in a situation in which the FIFO is either too full or too empty. That is, for example, if the variable delay approaches the capacity of the FIFO, the data in the FIFO could be depleted before new data are put in resulting in an undesirable interruption in data being delivered to the encoders. This is undesirably manifested as dead air.

On the other hand, if the delay is sufficiently short and data are delivered to the input of FIFO 204 more quickly than they are taken out at its output, the FIFO may fill up and data will get dropped. This results in other equally undesirable artifacts in the delivered audio stream.

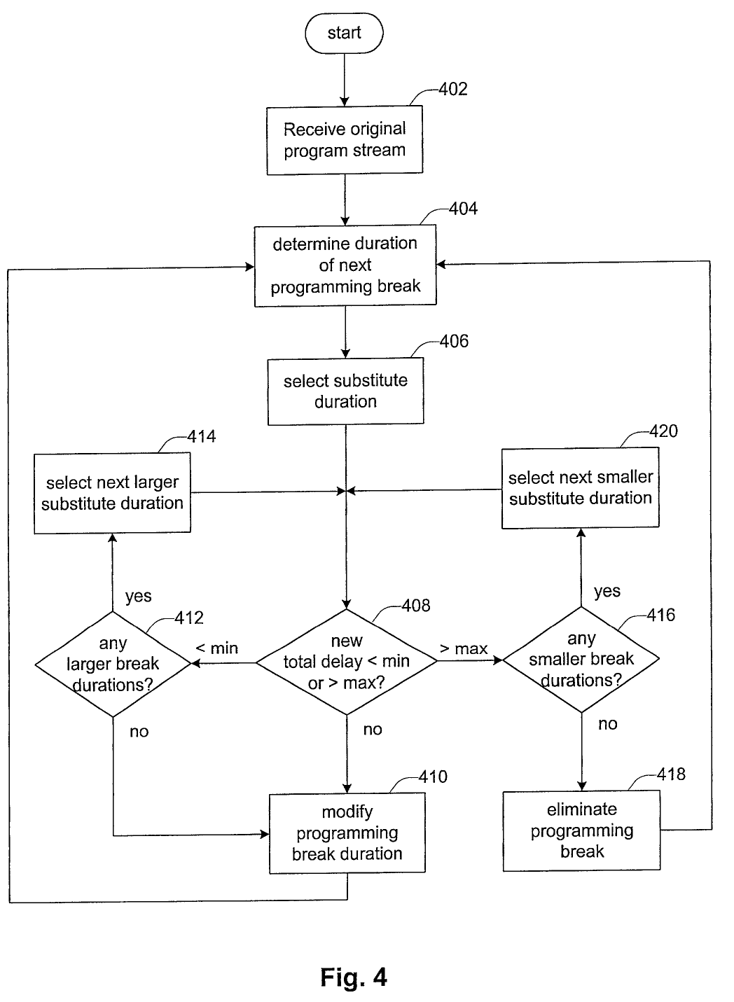

Referring now to FIG. 4, a specific embodiment will be described in which these issues are addressed. The original program stream is received (402) and the duration of the next programming break is determined (404). This may be done, for example, with reference to the information provided by the broadcast station's automation system regarding the segments in the broadcast radio program. A substitute duration is then selected from among a plurality of substitute duration with reference to the duration of the upcoming programming break (406). According to one embodiment, the plurality of substitute durations corresponds to specific predetermined values such as, for example, 15, 30, 45, and 60 seconds. According to another embodiment, the plurality of substitute durations includes values corresponding to the durations of each of the content segments in archives 134.

If substitution of the selected substitute duration for the programming break would result in a delay between the original program stream and the modified program stream which is within an acceptable predetermined range (i.e., the delay would not be greater than some maximum delay or less than some minimum delay) (408), the duration of the programming break is modified to the selected substitute duration (410), and the process then looks to the next programming break (404). As described above, and according to a specific embodiment, this is accomplished by supplying a sufficient number of samples of filler content, e.g., instrumental music, to the FIFO beginning where the original programming break would have begun and extending for the selected duration. This is then followed up with samples from the next music segment in the original program stream. Later substitution of alternate content in the modified programming break may occur at the end user or by a different process within the host. Alternatively, the alternate content may be inserted directly instead of the filler content.

According to one embodiment, the range of delay values which are acceptable are predetermined with reference to the capacity of the FIFO in which the filler and program data samples are combined. That is, an upper threshold is selected such that the greatest possible delta in the delay between the original program stream and the modified program stream would not result in starvation of the FIFO or the loss of data. Thus, for example, if the FIFO can handle a maximum of 3 minutes of data, the upper threshold might be set at 2 minutes. That is, the process would operate as described above unless use of a substitute duration would cause the delay between the original program stream and the modified program stream to exceed 2 minutes. Similarly, a lower threshold (e.g., 30 seconds) could be set to ensure that use of a substitute duration would not allow the delay between the two streams to go below this level. It will be understood that selection of these thresholds is somewhat arbitrary within the limits of the FIFO capacity, and that the thresholds may vary considerably without departing from the invention.

Referring once again to FIG. 4, if use of the selected substitute duration would cause the total delay to go below the lower threshold (408) as determined with reference to the amount of data currently in the FIFO, the system determines whether there are any larger substitute durations available (412). If not, the substitute duration is used (410). According to an alternative embodiment, a substitute duration is generated and used which prevents the delay from going below the threshold. If a larger substitute duration is available (412), the next largest duration is selected (414) and evaluated in the same manner. Once a larger duration is identified which is suitable, the process looks to the next programming break (404). According to an alternate embodiment, several shorter substitute durations may be concatenated to generate such a larger substitute duration.

If, on the other hand, use of the selected substitute duration would cause the total delay to exceed the upper threshold (408), the system determines whether there are any smaller substitute durations (416). If not, the programming break is completely eliminated (418) and the next programming break is evaluated (404). According to an alternate embodiment, a substitute duration is generated and used which prevents the delay from exceeding the threshold. If at least one smaller substitute duration exists (416), the next smaller duration is selected (420) and evaluated in the same manner. Once a smaller duration is identified which is suitable, the process looks to the next programming break (404).

According to a specific embodiment, the present invention also provides techniques for dealing with temporal drift between various versions of the original program stream, e.g., between the original program stream and the modified program stream. That is, small differences between clock rates for different circuitry in a computing network may result in the delay between the original program stream and the modified program stream drifting outside of the acceptable range discussed above. In the embodiment described above with reference to FIG. 4, this may be dealt with at programming breaks, for example, by selecting shorter or longer substitute durations. However, in situations where the time between programming breaks is very long, e.g., live coverage of U.S. Senate hearings, there may be no opportunity to deal with this issue.

Therefore, according to a specific embodiment, when it is determined that the delay between the original program stream and the delayed program stream is moving outside of its acceptable range, one or more samples from the original program stream are either duplicated or deleted to maintain the delay within the range. For example, if the delay between the original program stream and the delayed program stream were approaching the upper limit of the range (e.g., 2 minutes), one or more samples from the original program stream could be deleted to reduce the total delay. Similarly, if the delay were approaching the lower limit of the range (e.g., 30 seconds), one or more samples of the original program stream could be duplicated to increase the total delay. According to various embodiments, the samples deleted or duplicated may comprise a contiguous block of consecutive samples, or multiple groups of one or more samples separated by intervening samples in the original program stream.

According to an even more specific embodiment, the block of duplicate samples inserted into the stream is selected to minimize the audible artifacts of the insertion. That is, once it is determined that some number X of additional samples are required, the most recent ½ X samples are duplicated in reverse order and then duplicated again in their original order. The eliminates first order discontinuities in the stream. It also introduces frequency content already present in the stream, thereby reducing the more undesirable audible results of the insertion.

According to another specific embodiment, the block of samples removed from the stream are selected to minimize the audible artifacts for the deletion. That is, once it is determined that some number Y of samples should be removed from the stream, the next set of Y samples are gradually attenuated (i.e., a “fade out”), and the next set of Y samples after that are gradually brought back up to their original values (i.e., a “fade in”). These two sets of Y samples are then superimposed such that only Y samples remain, i.e., Y samples have been eliminated.

According to another specific embodiment, the number of samples in some appropriate block of samples is changed to be larger or smaller using any conventional sample rate conversion technique.

While the invention has been particularly shown and described with reference to specific embodiments thereof, it will be understood by those skilled in the art that changes in the form and details of the disclosed embodiments may be made without departing from the spirit or scope of the invention. That is, although specific embodiments of the invention have been described in the context of a Internet radio station, it will be understood that the present invention may be deployed with any system delivering streaming digital content including, for example, satellite or cable radio or television systems.

Also, the programming breaks described herein are not limited to the insertion of commercial spots. That is, the duration of any segments within a digital content stream may be manipulated and the content be replaced according to the techniques described herein without departing from the invention. For example, instead of a geographically relevant commercial spot, a local public service announcement or news segment might be inserted into a programming break generated according to the present invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. At least one computer-readable medium having computer program instructions stored therein for enabling a computer to manipulate programming breaks in an original digital content stream, the computer program instructions comprising:
first instructions operable to select one of a plurality of substitute durations with reference to a first duration of a first programming break; and
second instructions operable to substitute the selected substitute duration for the first duration and thereby generate a modified digital content stream having a modified programming break.

2. The at least one computer-readable medium of claim 1 wherein the modified digital content stream is characterized by a variable delay which varies with manipulation of the programming breaks, the computer program instructions further comprising third instructions operable to select a different substitute duration where substitution of the selected substitute duration for the first duration would cause the variable delay to be outside of a delay range.

3. The at least one computer-readable medium of claim 2 wherein the computer program instructions further comprise fourth instructions having a fixed delay associated therewith, the delay range being determined with reference to the fixed delay.

4. The at least one computer-readable medium of claim 3 wherein the fourth instructions implement a first-in-first-out delay buffer.

5. The at least one computer-readable medium of claim 2 wherein the delay range is characterized by a minimum delay and a maximum delay, and the third instructions are operable to select a larger substitute duration where substitution of the selected substitute duration for the first duration would cause the variable delay to be less than the minimum delay, and to select a smaller substitute duration where substitution of the selected substitute duration for the first duration would cause the variable delay to be greater than the maximum delay.

6. The at least one computer-readable medium of claim 5 wherein the computer program instructions further comprise fourth instructions operable to eliminate the first program break where substitution of the selected substitute duration for the first duration would cause the variable delay to be greater than the maximum delay and where the selected substitute duration is the smallest substitute duration.

7. The at least one computer-readable medium of claim 5 wherein the computer program instructions further comprise fourth instructions operable to substitute the selected substitute duration for the first duration where substitution of the selected substitute duration for the first duration would cause the variable delay to be less than the minimum delay and where the selected substitute duration is the largest substitute duration.

8. The at least one computer-readable medium of claim 2 wherein the variable delay also varies with a difference between a first clock rate and a second clock rate, the computer program instructions further comprising fourth instructions operable to insert and delete samples to and from the modified digital content stream to keep the variable delay in the delay range.

9. The at least one computer-readable medium of claim 1 wherein the second instructions are further operable to insert filler content in the modified programming break.

10. The at least one computer-readable medium of claim 9 wherein the filler content comprises instrumental music.

11. The at least one computer-readable medium of claim 1 wherein the computer program instructions further comprise third instructions operable to insert alternate content in the modified programming break.

12. The at least one computer-readable medium of claim 11 wherein the alternate content is also characterized by the selected substitute duration.

13. The at least one computer-readable medium of claim 11 wherein the third instructions are further operable to select the alternate content from an archive having a plurality of alternate content segments, each of the alternate content segments corresponding to one of the substitute durations.

14. The at least one computer-readable medium of claim 13 wherein selected ones of the alternate content segments are characterized by the corresponding substitute duration.

15. The at least one computer-readable medium of claim 11 wherein the alternate content comprises geographically relevant content.

16. A system including the at least one computer-readable medium of claim 1.

17. The system of claim 16 wherein the original digital content stream comprises any of audio data, video data, graphics data, text data, and control data.

18. The system of claim 16 wherein the system comprises a computer system in a wide area network.

19. The system of claim 16 wherein the system comprises a digital radio station.

20. The system of claim 19 wherein the digital radio station is one of an Internet radio station, a cable radio station, and a satellite radio station.

21. The system of claim 19 wherein the computer program instructions further comprise third instructions operable to insert alternate content in the modified programming break, and wherein the first and second instructions are stored in a first computer-readable medium associated with the digital radio station.

22. The system of claim 21 wherein the third instructions are stored in a second computer-readable medium associated with a user machine.

23. The system of claim 21 wherein the third instructions are stored in the first computer-readable medium.

24. A computer-implemented method comprising transmitting at least a portion of the computer program instructions of claim 1 in a wide area network.

25. A computer-implemented method for manipulating programming breaks in an original digital content stream, the method comprising:
selecting one of a plurality of substitute durations with reference to a first duration of a first programming break; and
substituting the selected substitute duration for the first duration, thereby generating a modified digital content stream having a modified programming break.

26. The method of claim 25 wherein the modified digital content stream is characterized by a variable delay which varies with manipulation of the programming breaks, the method further comprising selecting a different substitute duration where substitution of the selected substitute duration for the first duration would cause the variable delay to be outside of a delay range.

27. The method of claim 26 further comprising determining the delay range with reference to a fixed delay.

28. The method of claim 27 wherein the fixed delay is associated with a first-in-first-out delay buffer.

29. The method of claim 26 wherein the delay range is characterized by a minimum delay and a maximum delay, and selecting a different substitute duration comprises selecting a larger substitute duration where substitution of the selected substitute duration for the first duration would cause the variable delay to be less than the minimum delay, and selecting a smaller substitute duration where substitution of the selected substitute duration for the first duration would cause the variable delay to be greater than the maximum delay.

30. The method of claim 29 further comprising eliminating the first program break where substitution of the selected substitute duration for the first duration would cause the variable delay to be greater than the maximum delay and where the selected substitute duration is the smallest substitute duration.

31. The method of claim 29 further comprising substituting the selected substitute duration for the first duration where substitution of the selected substitute duration for the first duration would cause the variable delay to be less than the minimum delay and where the selected substitute duration is the largest substitute duration.

32. The method of claim 26 wherein the variable delay also varies with a difference between a first clock rate and a second clock rate, the method further comprising inserting and deleting samples to and from the modified digital content stream to keep the variable delay in the delay range.

33. The method of claim 25 further comprising inserting filler content in the modified programming break.

34. The method of claim 33 wherein the filler content comprises instrumental music.

35. The method of claim 25 further comprising inserting alternate content in the modified programming break.

36. The method of claim 35 wherein the alternate content is also characterized by the selected substitute duration.

37. The method of claim 35 further comprising selecting the alternate content from an archive having a plurality of alternate content segments, each of the alternate content segments corresponding to one of the substitute durations.

38. The method of claim 37 wherein selected ones of the alternate content segments are characterized by the corresponding substitute duration.

39. The method of claim 35 wherein the alternate content comprises geographically relevant content.
